(19) United States
(12) Patent Application Publication
(10) Pub. No.: US 2007/0274334 A1
(43) Pub. Date: Nov. 29, 2007

(54) Contention Resolution Protocol For A Shared Channel

(75) Inventor: Ronald Rietman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,603

(22) PCT Filed: Apr. 1, 2005
(86) PCT No.: PCT/IB05/51090

§ 371 Date: Oct. 3, 2006

(30) Foreign Application Priority Data
Apr. 7, 2004 (EP) 04101435.8

(51) Int. Cl. H04L 12/413

(52) U.S. Cl. 370/445

(57) ABSTRACT

A method of controlling a window in a contention resolution protocol for a shared channel between at least three contending stations, according to which a station contends for a channel over a number of steps by generating a number, x, within an interval with a lower bound, l, initially equal to an initial lower bound, L, and an upper bound, h, initially equal to an initial upper bound, U; and by trying to access the channel if the number, x, falls within a window with the lower bound, l, and an upper window bound, w; a station which generated a number outside the window is eliminated from contending for the channel; whereas a station which generated a number within the window continues to contend for the channel; the method continues until one station is singled out to be determined winning the contention; the method comprises a step of: setting the upper window bound, w, to set a window within which the expected number of stations that will try to access the channel is approximately equal to 1. In a preferred embodiment the upper window bound, w, is set according to the following expressions: w=W (l, h)≡l+(h−l)/n where h≡U, and w=W (l, h)≡(l+h)2 otherwise; where n represents a number of contending stations or an estimated number of contending stations.

This invention relates to a protocol which handles contention resolution for a shared communications channel.

The protocol handles contention resolution for a shared channel with stations. The channel is shared to the extent that several stations can contend for the channel with the ultimate aim of winning an exclusive right to communicate via the channel. Stations not winning a contention are eliminated in the contention, but can contend for the channel again in a subsequent contention.

A station contends for the channel by generating a random or pseudo random number within a given numerical interval e.g. the interval from 0 to 1, which random number of each station is evaluated as to whether the random number is within a window with a lower and an upper bound located within the given numerical interval. During one or more steps the lower and/or upper bound of the window is changed until one station with a number within the window is singled out. This station wins the contention resolution and thereby the exclusive right to communicate via the channel. Thus, a station with a number within the upper and lower bounds of the window continues to contend for the channel as long as its generated number is within the window, whereas stations with numbers not within the window are eliminated in the contention.

Different applications of such a protocol exist and the process of contention resolution can be performed in different ways within the scope of the above paragraph and at different points in time in response to different types of events. Contention resolution is however as a general rule applied whenever there is a need to grant one station among several stations a right to use a channel. The right to use of the channel can be limited to transmitting a given number of data packets, a given number of bytes or it can be limited to a specified time interval or as long as the station operates in a given mode.

For most applications it is the ability of the protocol to provide channel allocation to stations at a relatively low data overhead that is found to be expedient. Thus the protocol is particularly expedient when the contention resolution of the protocol is performed frequently. This may be the case in different types of networks e.g. wireless networks where the channel is shared among networked stations which can be connected and disconnected during operation of the network.

Additionally, the protocol is more flexible and robust than fixed allocation schemes like time division multiple access, TDMA and frequency division multiple access, FDMA.

The efficiency of the contention resolution protocol however relies to a very large extent on the algorithm that is applied to calculate new lower bounds and/or upper bounds of the window when it is to be changed. This algorithm is also denoted a window control rule.

U.S. Pat. No. 4,630,264 discloses such a contention-resolution protocol on a shared channel between stations. Here, each station maintains a common window and a station contending for the use of the channel generates a number. If the number generated falls in the window, the stations contends in a next time slot, otherwise it has to wait until the current contention has been resolved and a packet has been transmitted from the station that won the contention. A collision-detection rule is applied that detects whether one or more stations have contended. If more than one station has contended, or if no station has contended, a window-control rule is applied at each station to expand, shrink or otherwise change the window. The process is repeated until exactly one station has contended. The packet of data can then be sent.

Two computationally different approaches for the window-control are mentioned in the above disclosure. A first approach is based on a precise calculation of new bounds of the window when it is to be changed i.e. expanded, shrinked or moved. The precise calculation is based on the probability density distribution of the random numbers and involves rather complex calculations which takes up a substantial amount of computational time. On the one hand these calculations can be performed on the fly as the protocol is performing the contention-resolution and immediately before the window is to be changed. Thereby the precise calculation is obtained at the cost of computationally complexity and thus either at the cost of stronger processors or at the cost of longer duration of the contention resolution. Thus, although the precise calculation is optimal in terms of minimizing the number of future contention slots, it incurs high computational complexity, which makes it infeasible for real-time evaluation. On the other hand, results of the precise calculations can be pre-calculated and stored in a look-up table to thereby reduce the effort of providing the results during contention resolution. However, this is obtained at the cost of storage means arranged to contain the look-up table.

A study of the look-up table approach reveals that for a maximum of 32 stations the look-up table will take up about 2 MB of memory when each entry is stored in single precision i.e. 4 bytes per entry in the look-up table. For a maximum of 64 stations the storage requirement will amount to as much as 17 MB of memory.

Still according to U.S. Pat. No. 4,630,264 it is also proposed to apply a simplified window control rule which however arrives at the simplified rule at the cost of a slight increase in the number of expected future contention slots. The simplified rule is based on the following formulation: w=(a+b)/2 wherein a is the lower bound of the window, b is upper bound of the window and w is a new upper bound. This simplified algorithm is a compromise between the precise calculation and the look-up table approach. Simulations have shown that it has an almost load independent behavior and needs an average of 2.4 cycles to resolve contention almost regardless of network load. However, more detailed simulations have revealed that the asserted average of cycles to resolve contention is far in excess of 2.4 cycles when as less as more than 5 stations contend for a channel. This excess becomes further pronounced as more stations are involved; for about 10 stations the average has increased about 50% and for about 100 stations the average has increased about 300%. This will inherently slow down contention resolution and thus degrade performance of the network significantly.

The above and other problems are solved according to the present invention when the contention resolution is performed by means of the method summarized in the below paragraph.

The method involves controlling a window in a contention resolution protocol for a shared channel between at least three contending stations, according to which a station contends for a channel over a number of steps by generating a number, x, within an interval with a lower bound, l, initially equal to an initial lower bound, L, and an upper bound, h, initially equal to an initial upper bound, U; and by trying to access the channel if the number, x, falls within a window with the lower bound, l, and an upper window bound, w; a station which generated a number outside the window is eliminated from contending for the channel; whereas a station which generated a number within the window continues to contend for the channel; the method continues until one station is singled out to be determined winning the contention; the method comprises a step of:

setting the upper window bound, w, to set a window within which the expected number of stations that will try to access the channel is approximately equal to 1.

This window has shown a better performance in terms of solving a contention in as few iterations as possible. The invention proposes a method of calculating a window that performs well, is computationally trivial and does not need any lookup tables. If the number of stations contending for the channel is not available, the upper window bound, w, can be set to define a window within which an expected number of stations that will try to access the channel is approximately halved.

In an embodiment of the present invention, the upper window bound, w, is set such that the probability P1 that the generated number, x, is less than or equal to the upper window bound, w, minus the probability P2 that the generated number, x, is less than or equal to the lower bound, l, is approximately equal to one divided by an approximate number of contending stations.

In a preferred embodiment according to the present invention, the upper window bound, w, is calculated according to the following expressions:

$$w = W ( l , h ) = \{ \begin{matrix}{F}^{- 1} ( F ( l ) + \frac{1 - F ( l )}{n} ) & if h ≅ U \\ {F}^{- 1} ( \frac{F ( l ) + F ( h )}{2} ) & if h < U\end{matrix}$$

where the generated number, x, has a probability distribution F on [L,U] with F(L)=0 and F(U)=1 and where F is invertible such that there exists a function F⁻¹ with F⁻¹(F(x))=x, and where n represents a number of contending stations or an estimated number of contending stations. Thereby a station with a lowest of the generated numbers will win the contention resolution. The above expressions exhibit a good trade-off between computational complexity and performance in terms of solving the contention resolution in as few steps as possible. Especially, when h is approximately equal to the upper limit U, F(h) need not be calculated.

To solve the contention in fewest possible contention resolution steps where the number, x, is generated from a uniform or approximately uniform distribution, the upper window bound is set according to the following expressions:

$$w = W ( l , h ) ≅ l + \frac{h - l}{n}$$

where h≅U, and

$$w = W ( l , h ) ≅ \frac{l + h}{2}$$

otherwise.

Efficiently, the method of contention resolution comprises the steps of: detecting whether a collision occurs or whether the channel is idle; if a collision occurs setting l′=l; h′=w; if instead the channel is idle setting l′=w; h′=h; calculating w′=W(l′,h′); and updating the interval and window bounds by setting l=l′; w=w′; h=h′. Thereby, the window is set efficiently when the station with the lowest number, x, is to be selected.

This solution according to the present invention, denoted RR, has been simulated to compare it with the prior art (U.S. Pat. No. 4,630,264), denoted Wah, of only applying the last of the two above-mentioned expressions. Table 1 below shows the result of the simulation as an expected number of steps required to arrive at a resolved contention where one of n stations is singled out.

TABLE 1

| n | Steps, Wah | Steps, RR |
|---|---|---|
| 2 | 2.000 | 2.000 |
| 3 | 2.333 | 2.175 |
| 5 | 2.956 | 2.301 |
| 10 | 3.893 | 2.389 |
| 100 | 7.151 | 2.464 |

Thus the present invention provides a substantially improved performance over the prior art.

In case it is desired to select the station with the highest of the generated numbers, a window with a lower window bound, w, and the upper bound, h is to be used, where the lower window bound, w, is expediently calculated according to the following expression:

$$w = W ( l , h ) = \{ \begin{matrix}{F}^{- 1} ( F ( h ) ( 1 - \frac{1}{n} ) ) & if l ≅ L \\ {F}^{- 1} ( \frac{F ( l ) + F ( h )}{2} ) & if l > L\end{matrix}$$

where the generated number, x, has a probability distribution F on [L,U] with F(L)=0 and F(U)=1 and where F is invertible such that there exists a function F⁻¹ with F⁻¹(F(x))=x, and where n represents a number of contending stations or an estimated number of contending stations.

To solve the contention in fewest possible contention resolution steps where the number, x, is generated from a uniform or approximately uniform distribution, the lower window bound is set according to the following expressions:

$$w = W ( l , h ) ≅ h - \frac{h - l}{n}$$

where l≅L, and

$$w = W ( l , h ) ≅ \frac{l + h}{2}$$

otherwise.

Efficiently, the method of contention resolution comprises the steps of: detecting whether a collision occurs or whether the channel is idle; if the channel is idle setting l′=l; h′=w; if instead a collision occurs setting l′=w; h′=h; calculating w′=W(l′,h′); and updating the interval and window bounds by setting l=l′; w=w′; h=h′. Thereby, the window is set efficiently when the station with the highest number, x, is to be selected.

Expediently, a station is arranged to maintain values representing the bounds of the window and a generated number, and wherein the station evaluates whether the generated number falls within the window and obtains information about the status (idle, success, collision) of the channel; if the information indicates that the channel is idle or a collision have occurred and if the generated number falls within the window at least one of the window bounds is changed as set forth above and the station tries to communicate on the channel. Thereby, the station continues to contend for the channel and it can contend for the channel with a very limited use of the channel during contention, which will lead to a higher payload throughput. It should be noted that status of the channel is obtained for a given timeslot of the contention resolution in order to make a decision on how to set the window for a next timeslot. Additionally, it should be noted that ‘success’ means that one station has been singled out and thus won the contention.

Additionally, the invention relates to a computer program product comprising code means for performing the method above method when executed on a computer.

The invention also relates to an apparatus comprising a contention resolution processor which is arranged to operate according to the method set forth in the above.

Preferably, the apparatus comprises transmission and receiving means arranged to communicate via a channel in a wireless medium.

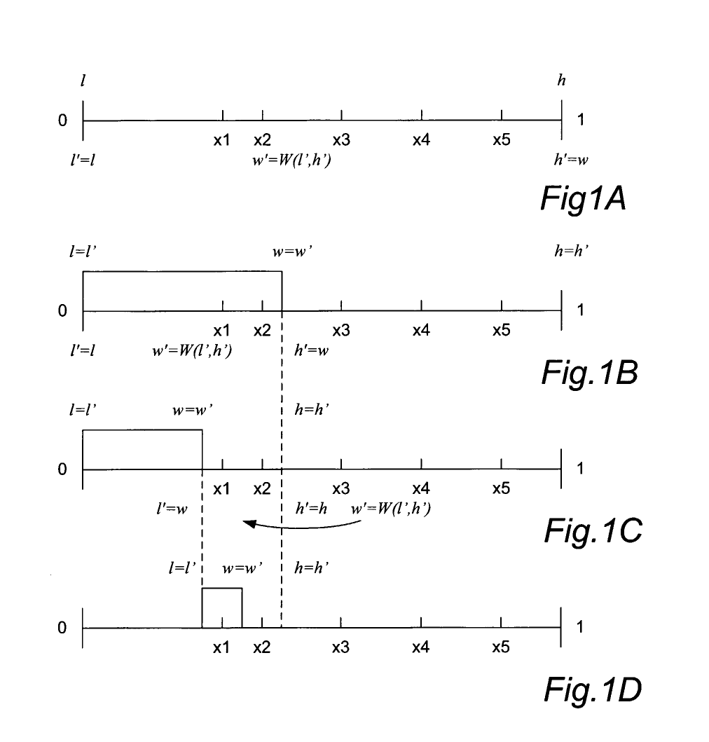

FIG. 1 illustrates the principle of the protocol arranged to handle contention resolution;

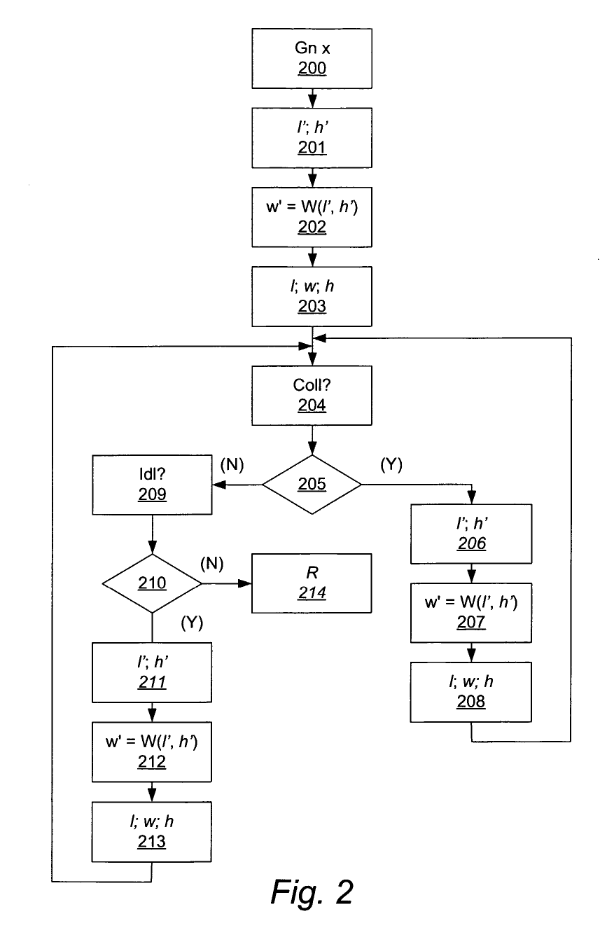

FIG. 2 shows a flowchart of a method for controlling a window; and

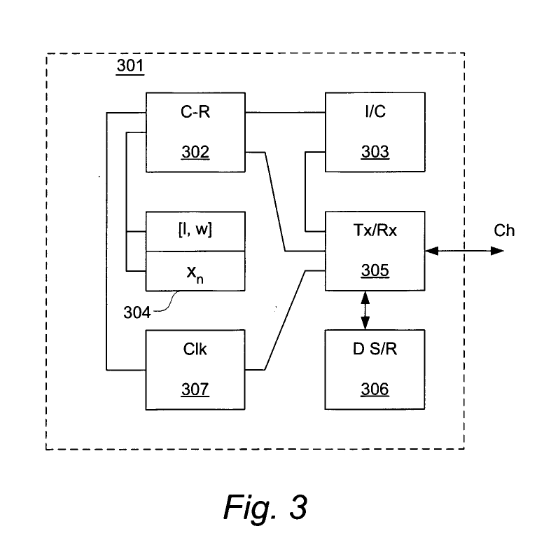

FIG. 3 shows a station.

FIG. 1 illustrates the principle of the protocol arranged to handle contention resolution. The principle is illustrated by means of a numerical scale generally spanning values in an interval from a lower bound, L, to an upper bound, U, selected to 0 and 1, respectively. The principle is shown in four steps designated capital letters A to D. In a first step, A, five stations contending for a channel generates respective real valued numbers designated x1, x2, x3, x4 and x5. Thus, x1 is a first number designating a first station, x2 is a second number designating a second station and so forth. The algorithm is explained from the aim of selecting the station with the lowest number, but can be modified to select the station with the greatest number.

A window is defined by a first bound, l, and a second bound, w. In accordance with the protocol, this window defines which of the stations among the stations contending for the channel that are allowed to try to communicate on the channel and thus to continue to contend for the channel. The stations allowed to continue are only the stations with a number, x1, x2, . . . ,x5, within the bounds of the window. These stations are allowed to try to communicate on the channel. If more than one station tries to communicate on the channel, a collision will very likely occur. Such a collision can be detected and this detection provides an indicator of whether more than one station is contending for the channel. If more than one station is contending for the channel, the contention has not been resolved yet, and the window is changed by being shrinked or moved iteratively until no collision or idle state of the channel can be detected and consequently one station has won the contention and thereby the right to communicate on the channel. Since during the contention resolution the only stations allowed to continue to contend for the channel are those with a number within the bounds of the window, other stations will be eliminated from the continued contention like in an elimination race. These stations can contend for the channel in a subsequent contention resolution e.g. when the winning station has transmitted a data packet on the channel.

To resume this description of the principle, five numbers are generated in step A. The lower bound of the window is determined by the variable l and this variable is set to the value 0. The variable h designates a present greatest possible value of the window. At this initial step the window is set to w=h in which case all five stations will try to communicate on the channel with the result that a collision can be detected. In this case, intermediate variables l′ is set equal to l; h′ is set equal to w and w′ is calculated w′=W(l′,h′). Subsequently, the variables l, h, and w are updated with the values of the intermediate variables: l=l′; w=w′; h=h′.

At this stage, B, the window [l, w] captures the values x1 and x2 whereby two stations are allowed to try to communicate on the channel whereas the other three stations are eliminated from the contention. Thereby it can be deduced that the contention is not resolved yet, since a collision can be detected. Again, in this case, intermediate variables l′ is set equal to l; h′ is set equal to w and w′ is calculated w′=W(l′,h′). Subsequently, the variables l, h, and w are updated with the values of the intermediate variables: l=l′; w=w′; h=h′.

At this stage, C, the window [l, w] does not capture any number and the channel remains idle since no station is allowed to try to grab the channel.

Now, since it can be detected that the channel remains idle, intermediate variables l′ are set equal to w; h′ is set equal to h and w′ is calculated w′=W(l′,h′). Subsequently, the variables l, h, and w are updated with the values of the intermediate variables: l=l′; w=w′; h=h′. This corresponds to swapping the window from [l; w] to [w; h] and additionally shrinking the window since it is known that the collision present at stage B will be present in [w; h]. Therefore, the resulting window is that shown at stage D.

At the subsequent stage, D, the window [l, w] captures exactly one number and thus only one station is allowed to communicate on the channel. This station is determined winning the contention resolution.

Thus in other words, the protocol handles contention resolution for a shared channel with a number of stations. Based on each contending station randomly choosing a number between e.g. 0 and 1, the protocol, in a number of steps, for each step calculates a window such that ultimately only one station is isolated in the window. This station wins the contention.

FIG. 2 shows a flowchart of a method for controlling a window. In a first step 200, each station contending for a channel generates a number x which represents a respective station.

For sake of simplicity the upper bound, U, and the lower bound, L, of the interval within which the numbers are generated assume the values 0 and 1.

In the following description of the flowchart it is firstly described with reference to selecting a station with a lowest number and a uniform probability distribution on the interval [0; 1] within which the numbers x are generated. Secondly, an embodiment selecting a largest number is described. Moreover, embodiments based on non-uniform probability distributions of the generated numbers, x, are described.

In step 201 the first bound, l, of the window is set to 0 and the variables h and w are set to 1. Additionally, intermediate variables l′ and h′ are set to the values of l and w, respectively.

Moreover, in step 202, w′ is calculated as:

$${w}^{′} = W ( {l}^{′} , {h}^{′} ) ≅ {l}^{′} + \frac{{h}^{′} - {l}^{′}}{n}$$

where n is an expected number of stations contending for the channel in a next timeslot. This number of stations can be estimated by known methods.

In subsequent step 203 the variables l, h and w are updated: l=l′; w=w′ and h=h′. The resulting window [l, w] is set with a first and second bound l, w.

Following step 203, each station with a generated number within the window [l, w] is allowed to try to transmit on the channel. In step 204 it is determined whether any collision occurs as a result of more than one station trying to transmit on the channel. In the affirmative event (Y), the method is directed, via step 205, to step 206 wherein the variables l′ and h′ are set equal to l and w, respectively, and in subsequent step 207, w′ is calculated: w′=W(l′,h′). Here, w′ is set according to the following expressions:

$${w}^{′} = W ( {l}^{′} , {h}^{′} ) ≅ {l}^{′} + \frac{{h}^{′} - {l}^{′}}{n}$$

where h′≅U, and

$${w}^{′} = W ( {l}^{′} , {h}^{′} ) ≅ \frac{{l}^{′} + {h}^{′}}{2}$$

otherwise;

In the following step 208 the variables are updated: l=l′; h=h′; and w=w′. The resulting window [l, w] is set with a first and second bound l, w.

After step 208 the method resumes step 204 during which stations with a number within the window set in step 208 are allowed to try to transmit on the channel. Again, it is determined whether any collision occurred on the channel. In case no collision is detected (N), the method is directed to step 209 via step 205. In step 209 it is determined whether the channel is idle (Y) or not (N).

In case the channel is idle, the variables, l′ and h′ are set equal to w and h, respectively, in step 211. In the following step 212, w′ is calculated: w′=W(l′,h′). Again, w′ is set according to the following expressions:

$${w}^{′} = W ( {l}^{′} , {h}^{′} ) ≅ {l}^{′} + \frac{{h}^{′} - {l}^{′}}{n}$$

where h′≅U, and

$${w}^{′} = W ( {l}^{′} , {h}^{′} ) ≅ \frac{{l}^{′} + {h}^{′}}{2}$$

otherwise;

In the following step 213 the variables are updated: l=l′; h=h′; and w=w′. The resulting window [l, w] is set with a first and second bound l, w. Thereby, allowing stations to transmit during step 204 at which the method resumes after the window has been set in step 213.

In case the channel was determined in step 209 not to be idle it must be occupied by a single station as there was no collision in the former step 204. This single channel is determined to be the one which is singled out or resolved as the station winning the contention for the channel. Thus the method for contention resolution aims at arriving at step 214 with a winning station.

In the event that the numbers, x, are not generated under a uniform probability distribution a more general approach for calculating the second bound, w; w′, of the window can be applied without departing from the scope of the invention. In this event the following expression is applied:

$$w ( l , h ) = \{ \begin{matrix}{F}^{- 1} ( F ( l ) + \frac{1 - F ( l )}{n} ) & if h ≅ U \\ {F}^{- 1} ( \frac{F ( l ) + F ( h )}{2} ) & if h < U\end{matrix}$$

Here, the generated numbers, x, have a distribution represented by the function F on the interval [L, U] i.e. more formally: P(X≦x)=F(x) for xε[L, U] with F(L)=0 and F(U)=1, where F is invertible i.e. there exists a function F⁻¹ such that F⁻¹(F(x))=x.

When the numbers are uniformly distributed, the function F is the identify function. Thus, it can be seen that the general formula above reduces to the formula for the uniform distribution.

Despite being described in connection with selecting the lowest number, x, the method can be modified to select the largest number. This modification can be obtained by replacing the variables described above according to the following when L=0:

x: U−x

h: U−l

l: U−h

w: U−w

Or more generally:

x: L+U−x

h: L+U−l

l: L+U−h

w: L+U−w

Additionally, the intermediate variables are assigned values in the following way in step 206 and 211: If the channel is idle setting l′=l; h′=w; and calculating w′32 W(l′,h′); and alternatively if a collision occurs setting l′=w; h′=h; and calculating w′=W(l′,h′). The interval and window bounds are updated in the same way as described above, i.e. by setting l=l′; w=w′; h=h′.

FIG. 3 shows a station. The station 301 comprises a transmitter/receiver 305 which is arranged to communicate via a channel, Ch (not shown), that can be shared with other stations for communication between two or more stations. In this embodiment, the transmitter/receiver 305 is arranged to transmit payload data on the channel from a data source 306 and/or to receive payload data on the channel to the data source 306.

The station comprises a contention resolution processor 302 which is arranged to operate as explained in more detail in connection with the flowchart of FIG. 2. The station comprises a memory 304 which contains variables, l, w and h representing a window and a generated number contained in a variable xₙ. In order to provide for making decisions as to whether the channel is idle and whether there are collisions on the channel, the station 301 comprises a unit 303 providing signals indicative thereof.

The station additionally comprises a clock signal generator 307. This generator is arranged to provide timing signals to the processor 302 to provide for execution of contention resolution time slots at predetermined points in time. The clock generator 307 may be synchronized with other stations via the channel.

In accordance with the above-described invention, the second window bound, w, is set to a window within which the expected number of stations that will try to access the channel is approximately equal to 1. This window has shown a better performance in terms of solving a contention in as few iterations as possible. If the number of stations contending for the channel is not available, the second window bound, w, can be set to a window within which an expected number of stations that will try to access the channel is approximately halved.

In case of desiring to select the station with the lowest number as the one winning the contention and if the number of stations, n, starting to contend for the channel is known, it is known that none of the stations have been eliminated yet if h=U. In that case the window is reduced to expectedly capturing 1/n (i.e. one) of the stations among the stations which started to contend for the channel. In other cases some contenders may already have been eliminated; consequently, the window is reduced to expectedly capturing ½ of the stations among the stations contending in a former iteration of the method.

1. A method of controlling a window in a contention resolution protocol for a shared channel between at least three contending stations, according to which a station contends for a channel over a number of steps by generating a number, x, within an interval with a lower bound, l, initially equal to an initial lower bound, L, and an upper bound, h, initially equal to an initial upper bound, U; and by trying to access the channel if the number, x, falls within a window with the lower bound, l, and an upper window bound, w; a station which generated a number outside the window is eliminated from contending for the channel; whereas a station which generated a number within the window continues to contend for the channel; the method continues until one station is singled out to be determined winning the contention; the method comprises a step of:
setting the upper window bound, w, to set a window within which the expected number of stations that will try to access the channel is approximately equal to 1.

2. A method according to claim 1, wherein the upper window bound, w, is set such that the probability P1 that the generated number, x, is less than or equal to the upper window bound, w, minus the probability P2 that the generated number, x, is less than or equal to the lower bound, l, is approximately equal to one divided by an approximate number of contending stations.

3. A method according to claim 1, wherein the upper window bound, w, is calculated according to the following expression:
$$w = W ( l , h ) = \{ \begin{matrix}{F}^{- 1} ( F ( l ) + \frac{1 - F ( l )}{n} ) & if h ≅ U \\ {F}^{- 1} ( \frac{F ( l ) + F ( h )}{2} ) & other w ise\end{matrix}$$
where the generated number, x, has a probability distribution F on [L, U] with F(L)=0 and F(U)=1 and where F is invertible such that there exists a function F⁻¹ with F⁻¹(F(x))=x; and where n represents a number of contending stations or an estimated number of contending stations.

4. A method according to claim 1, wherein the upper window bound, w, is set according to the following expressions:
$$w = W ( l , h ) ≅ l + \frac{h - l}{n}$$
where h≅U, and
$$w = W ( l , h ) ≅ \frac{l + h}{2}$$
otherwise;
where n represents a number of contending stations or an estimated number of contending stations.

5. A method according to claim 1, comprising the steps of:
detecting whether a collision occurs or whether the channel is idle;
if a collision occurs setting l′=l; h′=w;
if the channel is idle setting l′=w; h′=h;
calculating w′=W(l′,h′);
updating the interval and window bounds by setting l=1′; w=w′; h=h′.

6. A method of controlling a window in a contention resolution protocol for a shared channel between at least three contending stations, according to which a station contends for a channel over a number of steps by generating a number, x, within an interval with a lower bound, l, initially equal to an initial lower bound, L, and an upper bound, h, initially equal to an initial upper bound, U; and by trying to access the channel if the number, x, falls within a window with a lower window bound, w, and the upper bound, h; a station which generated a number outside the window is eliminated from contending for the channel; whereas a station which generated a number within the window continues to contend for the channel; the method continues until one station is singled out to be determined winning the contention; the method comprises a step of:
setting the lower window bound, w, to set a window within which the expected number of stations that will try to access the channel is approximately equal to 1.

7. A method according to claim 6, wherein the lower window bound, w, is set such that the probability P1 that the generated number, x, is greater than or equal to the lower window bound, w, minus the probability P2 that the generated number, x, is greater than or equal to the upper bound, h, is approximately equal to one divided by an approximate number of contending stations.

8. A method according to claim 6, wherein the lower window bound, w, is calculated according to the following expression:
$$w = W ( l , h ) = \{ \begin{matrix}{F}^{- 1} ( F ( h ) ( 1 - \frac{1}{n} ) ) & if l ≅ L \\ {F}^{- 1} ( \frac{F ( l ) + F ( h )}{2} ) & other w ise\end{matrix}$$
where the generated number, x, has a probability distribution F on [L,U] with F(L)=0 and F(U)=1 and where F is invertible such that there exists a function F⁻¹ with F⁻¹(F(x))=x; and where n represents a number of contending stations or an estimated number of contending stations.

9. A method according to claim 6, wherein the lower window bound, w, is set according to the following expressions:
$$w = W ( l , h ) ≅ h - \frac{h - l}{n}$$
where l≅L, and
$$w = W ( l , h ) ≅ \frac{l + h}{2}$$
otherwise;
where n represents a number of contending stations or an estimated number of contending stations.

10. A method according to claim 6, comprising the steps of:
detecting whether a collision occurs or whether the channel is idle;
if the channel is idle setting l′=l; h′=w;
if a collision occurs setting l′=w; h′=h;
and calculating w′=W(l′,h′);
updating the interval and window bounds by setting l=l′; w=w′; h=h′.

11. A method according to claim 1, wherein a station is arranged to maintain values representing the bounds of the window and a generated number, and wherein the station evaluates whether the generated number falls within the window and obtains information about the status of the channel; if the information indicates that the channel is idle or a collision has occurred and if the generated number falls within the window at least one of the window bounds is changed as set forth in claim 1 and the station tries to communicate on the channel.

12. A computer program product comprising code means for performing the method according to claim 1 when executed on a computer.

13. An apparatus comprising a contention resolution processor which is arranged to operate according to the method set forth in claim 1.

14. An apparatus according to claim 13, comprising transmission and receiving means arranged to communicate via a channel in a wireless medium.
